(19) United States
(12) Patent Application Publication
(10) Pub. No.: US 2024/0253327 A1
(43) Pub. Date: Aug. 1, 2024

(54) MOLDED BODY AND METHOD OF MANUFACTURING MOLDED BODY

(71) Applicant: Canon Medical Systems Corporation, Otawara-shi (JP)

(72) Inventor: Hidenori SOMA, Utsunomiya (JP)

(73) Assignee: Canon Medical Systems Corporation, Otawara-shi (JP)

(21) Appl. No.: 18/420,848

(22) Filed: Jan. 24, 2024

(30) Foreign Application Priority Data
Jan. 26, 2023 (JP) 2023-010510

(51) Int. Cl. B32B 5/26; B32B 5/02

(52) U.S. Cl. CPC B32B 5/26; B32B 5/02; B32B 2250/02; B32B 2250/20; B32B 2260/023; B32B 2260/046; B32B 2262/065; B32B 2262/101; B32B 2307/546; B32B 2307/56; B32B 2307/72; B32B 2435/00

(57) ABSTRACT

A molded body is a resin composition containing a resin, a glass fiber and a natural fiber. The molded body includes a laminated structure including a glass fiber layer made of the glass fiber and a natural fiber layer made of the natural fiber.

### CROSS-REFERENCE TO RELATED APPLICATION

This application is based upon and claims the benefit of priority from Japanese Patent Application No. 2023-010510, filed Jan. 26, 2023, the entire contents of which are incorporated herein by reference.

### FIELD

Embodiments described herein relate generally to a molded body and a method of manufacturing the molded body.

### BACKGROUND

As a cover part for use in a medical device such as an X-ray computed tomography (CT) device, a magnetic resonance imaging device, etc., a lightweight and highly rigid member is used from the point of view of damage resistance and deformation suppression. A cover member is made of, for example, a glass fiber reinforced resin (GFRP) material in which a glass fiber is impregnated with a resin. However, a molded body made of a GFRP material is high in rigidity but low in vibration damping and thus involves a problem wherein such a molded body resonates with vibrations generated in another component to generate abnormal noise. Furthermore, an internal mechanism that rotates at high speed is installed inside a gantry of an X-ray CT device, so that wind is generated when the internal mechanism rotates at high speed. Thus, there is also a problem wherein the cover member vibrates due to the effect of the generated wind, thereby generating noise. For this reason, a molded body used as a cover member for an X-ray CT device of an MRI device is required to have a high rigidity and a high vibration damping performance.

### BRIEF DESCRIPTION OF THE DRAWINGS

FIG. 1 is a diagram showing an example of a configuration of a molded body according to an embodiment.

FIG. 2 is a diagram showing an example of a method of manufacturing the molded body according to the embodiment.

FIG. 3 is a diagram for illustrating how a resin is injected from a state shown in FIG. 2.

FIG. 4 is a diagram for illustrating how a vibration damping test is performed using a test piece of the molded body according to the embodiment.

### DETAILED DESCRIPTION

In general, according to one embodiment, a molded body is a resin composition containing a resin, a glass fiber and a natural fiber. The molded body includes a laminated structure including a glass fiber layer made of the glass fiber and a natural fiber layer made of the natural fiber.

Hereinafter, embodiments of a molded body and a method of manufacturing the molded body will be described in detail.

### EMBODIMENT

### (Structure)

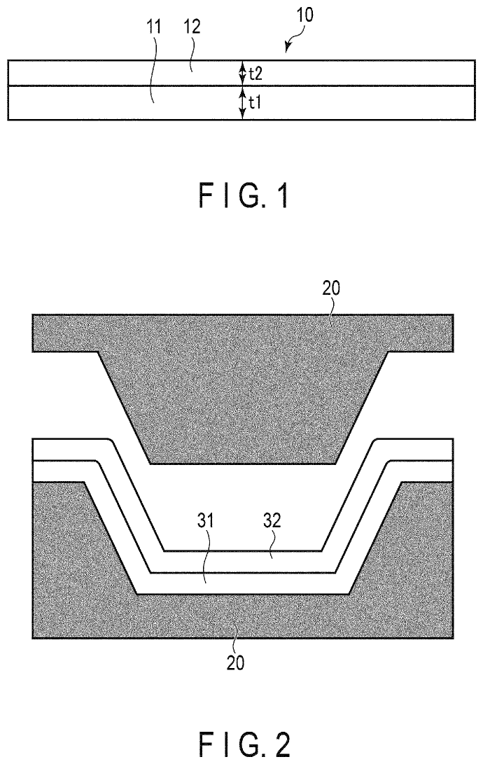

FIG. 1 is a diagram showing an example of a configuration of a molded body 10 according to an embodiment. The molded body 10 is mainly used as a cover member for a gantry of a medical device such as an X-ray CT device, an MRI device, etc. The molded body 10 is a resin composition in which a glass fiber and a natural fiber are mixed into a base resin. As shown in FIG. 1, the molded body 10 according to the present embodiment has a laminated structure composed of a glass fiber layer 11 containing the glass fiber and a natural fiber layer 12 containing the natural fiber. Examples of the base resin include a thermoplastic resin such as a polypropylene, a cycloolefin copolymer, etc., or a thermosetting resin such as an unsaturated polyester, an epoxy resin, etc.; however, the examples are not limited to these.

The glass fiber layer 11 is made of a glass fiber reinforced resin (GFRP) material made nonwoven by impregnating a glass fiber with a high material rigidity with a resin.

The natural fiber layer 12 is made of a vegetable fiber (NF) reinforcing material in which a natural fiber is impregnated with a thermosetting resin. Examples of the natural fiber include, for example, a vegetable fiber such as a wood fiber. As the natural fiber, for example, a fiber such as cotton, bamboo, linen, wool, etc., can be used. As the natural fiber used for the natural fiber layer 12, for example, a nonwoven wood fiber is used. Any type of thermosetting resin may be used. For example, an epoxy resin can be used as a thermosetting resin.

The glass fiber layer 11 is formed on the outside of the molded body 10, and the natural fiber layer 12 is formed on the inside of the molded body 10. For this reason, the glass fiber layer 11 is located on the outside of a cover member of a medical device, and the natural fiber layer 12 is located on the inside of the cover member of the medical device. The outside of the cover member corresponds to a portion exposed to the outside of the gantry, and the inside of the cover member corresponds to a portion opposed to an internal mechanism of the gantry.

The natural fiber layer 12 is formed to be thinner than the glass fiber layer 11. Thus, a thickness T2 of the natural fiber layer 12 is smaller than a thickness T1 of the glass fiber layer 11. A thickness ratio between the glass fiber layer 11 and the natural fiber layer 12 is not particularly limited; however, the thickness ratio is preferably set to, for example, T1:T2=2:1.

In the case where a total content ratio of the glass fiber and the natural fiber with respect to 100% by mass of the resin composition in the entire molded body 10 is greater than 70% by mass, the amount of resin in the resin composition is not enough to maintain a shape of the molded body, so that the molded body can no longer be processed. Furthermore, in the case where the aforementioned total content ratio with respect to the entirety of the molded body 10 is less than 30% by mass, the rigidity of the molded body 10 cannot be maintained. Therefore, the molded body 10 is manufactured in such a manner that a value of the total content ratio falls within the range of 30 to 70% by mass.

Furthermore, in order to maintain a product shape and suppress deformation during transportation, the molded body 10 is required to have a rigidity (flexural modulus) of 2.5 GPa or greater. More desirably, the molded body 10 is required to have a rigidity (flexural modulus) of 3.0 GPa or greater. Furthermore, in order to suppress vibrations caused by the influence from the internal mechanism, the molded body 10 is required to have a damping ratio of 0.046 or greater.

### (Effect)

Next, the effect of the molded body 10 configured as described above will be explained.

The molded body 10 according to the present embodiment is used as a component of a medical device such as a medical image diagnostic apparatus. The molded body 10 is used as, for example, a cover for a gantry of an X-ray CT device or an MRI device. As a cover part for use in a medical device, a lightweight and highly rigid member is used from the point of view of deformation suppression during transportation and damage resistance. In X-ray CT devices, a rotating member is arranged inside a gantry. Furthermore, in MRI devices, a gradient magnetic field coil that vibrates when energized is arranged inside a gantry. In this manner, an internal mechanism that rotates at high speed or that vibrates when energized is provided inside a gantry of an X-ray CT device or an MRI device. When the internal mechanism rotates at high speed, there is a possibility that wind will be generated to cause vibrations of a cover member under the influence of the generated wind, thereby generating noise. Furthermore, when the internal mechanism vibrates, the cover member vibrates under the influence of the vibrations, so that noise is generated from each of the internal mechanism and the cover member. For this reason, a molded body used as a cover member for an X-ray CT device or an MRI device is required to have high vibration damping performance and quietness.

The molded article 10 according to the present embodiment is a resin composition in which a glass fiber and a natural fiber are mixed into a base thermoplastic resin, and has a laminated structure including the glass fiber layer 11 containing a glass fiber and the natural fiber layer 12 containing a natural fiber. Examples of a natural fiber include a vegetable fiber.

The molded body 10 configured as described above maintains its lightness and rigidity while improving its vibration damping performance by adding the natural fiber layer 12 made of a natural fiber having a higher vibration damping performance than a glass fiber to the glass fiber layer 11 having a high material rigidity. That is, both material rigidity and vibration suppression can be achieved by using a natural fiber in addition to a conventional glass fiber. Therefore, in the case of using the aforementioned molded body 10 as a cover member for a medical device such as an X-ray CT apparatus or an MRI apparatus, vibrations of the cover member due to the influence of the internal mechanism can be suppressed, and quietness can be improved.

Furthermore, the glass fiber layer 11 and the natural fiber layer 12 are different in specific gravity. In general, in the case of having a plurality of fibers made finer and mixed together, a density difference of a material decreases, thereby easily causing resonance. On the other hand, in the case of having a laminated structure in which a plurality of layers having different specific gravities are laminated as in the present application, a frequency band of a vibration that each layer can absorb is different between the layers, so that resonance hardly occurs. Therefore, the vibration damping performance can be improved by forming a laminated structure from a plurality of fibers having different specific gravities, as compared to a case in which a plurality of fibers are made fine and mixed.

Furthermore, in the case of using a rubber-based (elastomer) material instead of a natural fiber, vibration damping can be obtained; however, the rigidity and heat resistance decrease, so that a conventional product strength can no longer be maintained. On the other hand, the molded body 10 according to the present embodiment uses a natural fiber, thereby being able to maintain its rigidity while having its vibration damping performance improved.

### (Manufacturing Method)

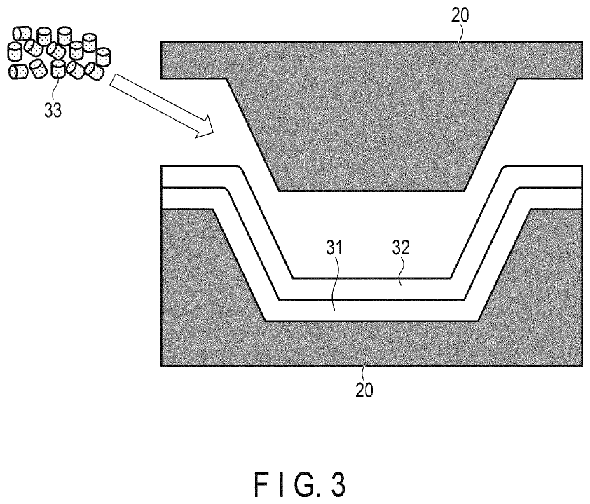

Next, a method of manufacturing the molded body 10 according to the embodiment will be described. Herein, a method of manufacturing the molded body 10 through compression molding using a compression molding machine will be described as an example. As the compression molding machine, a general compression molding machine is usable. FIG. 2 and FIG. 3 are each a diagram for illustrating the method of manufacturing the molded body 10.

In molding the molded body 10 by compression, first, as shown in FIG. 2, a glass fiber mat 31 containing a glass fiber and a natural fiber mat 32 containing a natural fiber are laminated and arranged inside a mold 20. At this time, the glass fiber mat 31 is arranged at a position outside the cover, and the natural fiber mat 32 is arranged at a position inside the cover. In the example shown in FIG. 2, a two-layer structure is formed by setting the glass fiber mat 31 in the mold 20, and then setting the natural fiber mat 32 on the top of the glass fiber mat 31 set first.

As the glass fiber mat 31, a general glass fiber mat is usable. As the natural fiber mat 32, for example, a thin prepreg mat formed by impregnating a thermosetting resin into a sheet formed by defibrating, washing, and drying a hemp fiber is usable.

After the glass fiber mat 31 and the natural fiber mat 32 are installed, a resin 33 is injected into the mold 20, as shown in FIG. 3. As the resin 33 to be injected, for example, a thermoplastic resin such as a cycloolefin copolymer or a thermosetting resin such as an epoxy resin is usable; however, this is not a limitation.

After the resin 33 is injected, compression molding is performed using a compression molding machine to mold the molding 10 having a laminated structure composed of the glass fiber layer 11 and the natural fiber layer 12. At this time, a general compression molding method can be used.

In the case of using a thermoplastic cycloolefin resin as the resin 33, the molded body 10 is molded by, for example, setting the molding temperature to 240 to 290° C., applying the surface pressure of 10 to 40 kN, and slowly cooling the molded body 10 at the cooling rate of 15° C./min to room temperature.

### EXAMPLES

Next, the embodiment will be described in more detail based on examples. However, the embodiment is not limited to these examples.

### Example 1

### <Natural Fiber Mat>

A sheet was prepared by defibrating, washing, and drying a hemp fiber, and the prepared sheet was impregnated with a thermosetting resin to prepare a thin prepreg natural fiber mat. Epoxy resin (product name: EP138, manufactured by Cemedine Co., Ltd.) was used as a thermosetting resin.

### <Glass Fiber Mat>

A chopped strand mat for hand layup (product name: MC380A, manufactured by Nittobo Co., Ltd.) was used.

### <Resin>

A thermoplastic cycloolefin resin (product name: ZEONEX E48R, manufactured by Zeon Corporation) was used.

### <Compression Molding Machine>

A compression molding machine (product name: FINE LABO PRESS SAP-1, manufactured by Toyo Seiki Seisaku-sho, Ltd.) was used.

### <Method of Manufacturing Molded Body>

For preparation of a test piece, a flat plate mold (a length of 300 mm and a width of 300 mm) was used, and a flat plate molded body was prepared by setting a glass fiber mat inside a mold, making a two-layer structure by laminating a natural fiber mat onto the glass fiber mat, and pouring a resin into the inside of the mold. The flat plate molded body (a length of 20 mm, a width of 200 mm, and a thickness of 2 mm) was obtained by cooling the body to room temperature at the cooling rate of 15° C./min under a condition whereby the mixing ratio of the fiber and the resin was 60:40 wt %, the molding temperature was 260° C., and a surface pressure of 10 MPa was used as the molding pressure.

### <Method of Evaluating Rigidity>

By cutting out a piece of specified dimensions (a length of 80 mm, a width of 10 mm, and a thickness of 2 mm) from the flat plate molded body and using it as a test piece, the flexural modulus was measured by a method based on JIS K6911 (1995).

### <Method of Evaluating Vibration Damping Performance>

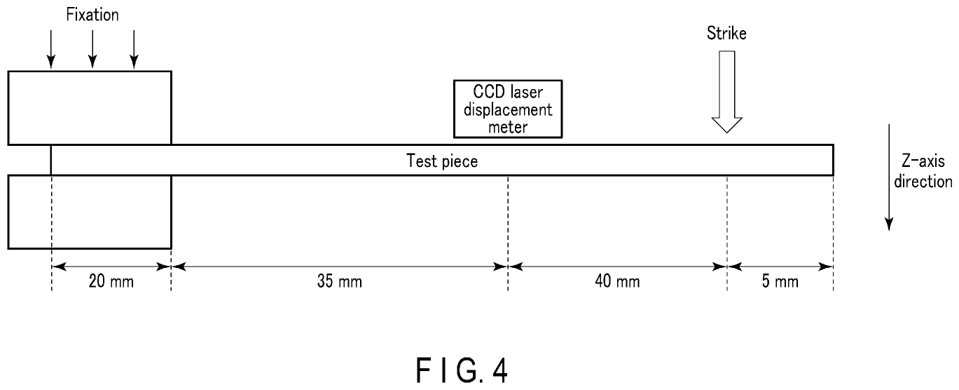

A damping ratio was measured as an evaluation value of vibration damping performance. The vibration damping test adopted a cantilever method. FIG. 4 is a diagram for illustrating the vibration damping test method. A test piece of specified dimensions (a length of 100 mm, a width of 10 mm, and a thickness of 2 mm) was cut out from the flat plate molded body and installed as shown in FIG. 4, and a vibration in a Z-axis direction was acquired using a CCD laser displacement meter after striking a portion 5 mm from the tip of the test piece so as to cause a deflection of 10 mm in the Z-axis direction. Thereafter, a frequency response function was calculated by performing Fourier transform on an obtained acceleration response, an amplitude ratio (a_n/a n+1) and a logarithmic damping rate δ (ln(a_n/a_n+1)) were calculated using the frequency response function, and an attenuation ratio ξ (δ/2n) was calculated from the logarithmic attenuation rate.

### Comparative Example 1

A flexural modulus and a damping ratio were measured through a similar process to that of Example 1, except that the test piece was prepared without using the natural fiber mat and the glass fiber mat.

### Comparative Example 2

A flexural modulus and a damping ratio were measured through a similar process to that of Example 1, except that the test piece was prepared using only the glass fiber mat without using the natural fiber mat.

### Comparative Example 3

A flexural modulus and a damping ratio were measured through a similar process to that of Example 1, except that the test piece was prepared using only the natural fiber mat without using the glass fiber mat.

### Example 2

### <Natural Fiber Mat>, <Glass Fiber Mat>, <Compression Molding Machine>

A similar material to that of Example 1 was used.

### <Resin>

A thermosetting epoxy resin (product name: EP138, manufactured by Cemedine Co., Ltd.) was used.

### <Condition for Preparation of Molded Body>

A flat plate molded body was prepared using a similar jig for preparation of a test piece to that of Example 1. The molded body was obtained at a molding temperature of 120 to 130° C. under a pressure of 20 to 40 kN.

### <Method of Evaluating Rigidity>

A method similar to that of Example 1 was used.

### <Method of Evaluating Vibration Damping Performance>

A damping ratio was measured using a similar method to that of Example 1.

### Comparative Example 4

A flexural modulus and a damping ratio were measured through a similar process to that of Example 2, except that the test piece was prepared without us ing the natural fiber mat and the glass fiber mat.

### Comparative Example 5

A flexural modulus and a damping ratio were measured through a similar process to that of Example 2, except that the test piece was prepared using only the glass fiber mat without using the natural fiber mat.

### Comparative Example 6

A flexural modulus and a damping ratio were measured through a similar process to that of Example 2, except that the test piece was prepared using only the natural fiber mat without using the glass fiber mat.

### [Comparison Result]

Table 1 shows the measurement results obtained in Examples 1 and 2 and Comparative Examples 1 to 6. In Table 1, “GF” indicates that a material contains the glass fiber, and “NF” indicates that the material contains the natural fiber.

TABLE 1

| | | | Comparative | Comparative | Comparative |
|---|---|---|---|---|---|
| | | Example 1 | Example 1 | Example 2 | Example 3 |
| Composition | Resin | Thermoplastic | Thermoplastic | Thermoplastic | Thermoplastic |
| | Fiber | GF | — | GF | NF |
| | | NF | | | |
| Flexural modulus (GPa) | | 3.0 | 2.2 | 3.6 | 2.8 |
| Damping ratio | | 0.050 | 0.021 | 0.030 | 0.039 |
| | | | Comparative | Comparative | Comparative |
| | | Example 2 | Example 4 | Example 5 | Example 6 |
| Composition | Resin | Thermosetting | Thermosetting | Thermosetting | Thermosetting |
| | Fiber | GF | — | GF | NF |
| | | NF | | | |

| | | | | |
|---|---|---|---|---|
| Flexural modulus (GPa) | 4.7 | 3.5 | 5.5 | 4.3 |
| Damping ratio | 0.060 | 0.027 | 0.040 | 0.045 |

As shown in Table 1, Comparative Example 1, which does not contain either the glass fiber or the natural fiber, exhibited a flexural modulus of smaller than 2.5 GPa and a damping ratio smaller than 0.046. This shows that neither the standard for the rigidity nor the standard for the vibration damping performance was satisfied. Furthermore, it is understood that Comparative Example 2, which contains only the glass fiber, and Comparative Example 3, which contains only the natural fiber, satisfied the flexural modulus standard of 2.5 GPa or greater but did not satisfy the damping ratio standard of 0.046 or greater. On the other hand, it is understood that Example 1 achieved, because both the glass fiber and the natural fiber are contained therein, both a flexural modulus of 2.5 GPa or greater and a damping ratio of 0.046 or greater.

Similarly, it is understood that Comparative Examples 4 to 6 satisfied the flexural modulus standard of 2.5 GPa or greater but did not satisfy the damping ratio standard of 0.046 or greater. On the other hand, it is understood that Example 2 realized, because both the glass fiber and the natural fiber are contained therein, both a flexural modulus of 2.5 GPa or greater and a damping ratio of 0.046 or greater.

The above results show that only a case in which both the glass fiber and the natural fiber are contained can maintain a shape of a product and achieve both rigidity for suppressing deformation during transportation and vibration damping for suppressing vibrations caused by internal mechanisms.

According to at least one embodiment described above, it is possible to provide a molded body that achieves both rigidity and vibration damping.

While certain embodiments have been described, they have been presented by way of example only, and they are not intended to limit the scope of the inventions. These embodiments may be worked in a variety of other forms with various omissions, substitutions, changes, and combinations without departing from the spirit of the inventions. The embodiments and their modifications are covered by the accompanying claims and their equivalents, as would fall within the scope and the gist of the claimed inventions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A molded body of a resin composition containing a resin, a glass fiber, and a natural fiber, the molded body comprising a laminated structure including a glass fiber layer containing the glass fiber and a natural fiber layer containing the natural fiber.

2. The molded body according to claim 1, wherein a total content ratio of the glass fiber and the natural fiber with respect to 100% by mass of the resin composition is 30 to 70% by mass.

3. The molded body according to claim 1, wherein the natural fiber is a vegetable fiber.

4. The molded body according to claim 1, wherein the molded body has a flexural modulus of 2.5 GPa or greater and a damping ratio of 0.046 or greater.

5. The molded body according to claim 1, wherein the molded body is used as a cover member for a medical device.

6. The molded body according to claim 5, wherein the glass fiber layer is located on an outside of the cover member, and
the natural fiber layer is located on an inside of the cover member.

7. The molded body according to claim 1, wherein the glass fiber layer and the natural fiber layer are different in specific gravity.

8. A method of manufacturing a molded body of a resin composition containing a resin, a glass fiber, and a natural fiber, the molded body comprising a laminated structure including a glass fiber layer containing the glass fiber and a natural fiber layer containing the natural fiber, the method comprising:
laminating and arranging in a mold a glass fiber mat containing the glass fiber and a natural fiber mat containing the natural fiber;
injecting a resin into the mold; and
molding the molded body by performing compression molding using the mold.
